(19) United States
(12) Patent Application Publication
(10) Pub. No.: US 2015/0070465 A1
(43) Pub. Date: Mar. 12, 2015

(54) INTERACTIVE TELEVISION

(71) Applicant: Tremain Ray, Westchester, IL (US)

(72) Inventor: Tremain Ray, Westchester, IL (US)

(21) Appl. No.: 14/020,764

(22) Filed: Sep. 6, 2013

(51) Int. Cl. H04N 5/64; G06F 3/041; H04N 13/02

(52) U.S. Cl. CPC H04N 5/64; H04N 13/02; G06F 3/041
USPC 348/46; 348/143

(57) ABSTRACT

An interactive television includes a plurality of features not available in a single television device. The interactive television includes a touch screen and can include features such as wireless internet access, a three-dimensional camera, a built-in surge protector, a surge protected outlet in the television base, and the like. The interactive television can include software for displaying time, time zones, calendars and the like. The interactive television can include an alarm clock and can be used for text messaging. The interactive television can include several technological advances in a single device, providing the user with a complete, interactive television experience.

### BACKGROUND OF THE INVENTION

The present invention relates to an interactive television and, more particularly, to an interactive television having a number of features, including telecommunication features.

Currently, televisions are limited in their interactions with the user. For example, one has to turn the channels to select different programs on the television, disturbing one's relaxation while watching television. Moreover, users often feel left out, because the television they're watching doesn't speak their native language. Additionally, a user is limited to watching one show at a time and they cannot communicate with others on the television. With conventional televisions, users are often unaware of when an upgrade is necessary, leaving unacceptable pixel squares and raster images on the television screen.

Many people enjoy watching television, but the television experience tends to be the mere delivery of entertainment with limited ability on the part of the viewer to enhance their experience, except by changing channels, volumes, and limited image controls such as contrast. Thus, the television viewer is a passive participant in the experience. However, there is not a device that allows one to be an active participant as a television viewer. Currently, there are no television devices which facilitate an enhanced visual experience for the television viewer. Televisions do not have a lot of enhanced features to allow the television viewer to become active.

With conventional television device, if a user turns up the volume they can disturb someone around the, especially if they are sleeping. Most televisions only have push buttons to change channels and turn up or down the volumes. Push buttons do not make it easy to zip through channels or turn the volume up or down faster. Most televisions are not compatible with all computers. They don't have the option or hook up for both Mac and PC computer. Additionally, most televisions do not have a camera or a video camera, preventing users to be able to show videos or take pictures, edit pictures, and edit videos. On most televisions, a user cannot listen to music on your CD because there no CD player built in the television.

Most conventional televisions are unreliable when it comes to emergency use, because there no communicate options to choose from in the television. Most televisions cannot show two or more television shows at once. Most televisions cannot make phone calls and allow the user to look at the person to which they are talking to on the other line—all this while still watching a television show. Most conventional televisions cannot allow a user to surf the Internet.

Currently, the highest resolution for traditional televisions is at 1080 p. Even using 1080 p resolution, the background is sometimes unintentionally blurred compared to the foreground. Most television only used red, green, and blue colors known as “(R.G.B.)”. This is only a fewer colors of the vision spectrum. By using only R.G.B. colors, conventional televisions do not give enough colors to the images being watched by the user. Most televisions do not have the option to select DVD or Blu-Ray player for movies or convert 2D to 3D to watch movies and television shows. Most televisions do not have options to allow the user to listen to a radio station or stored music and files. Conventional televisions typically to not have any wireless network connection, such as Bluetooth, and, therefore, a user cannot program their television with other Bluetooth devices. On conventional television, there are typically no WiFi connections, so a user cannot easily use the ‘internet. Most televisions do not have the option to let a user sent a text message to someone.

Most conventional televisions do not include an alarm to wake the user up in the morning, and they do not have a world clock to let the user know what time it is around the World. Most conventional televisions do not include a calendar that shows the days, months and years. Finally, most conventional televisions there co not have built in power surge protection.

As can be seen, there is a need for an interactive television that includes a plurality of interactive features, all built into a single interactive television device that includes telecommunication features built into the television.

### SUMMARY OF THE INVENTION

In one aspect of the present invention, an interactive television comprises a touch screen for displaying items to a user and for permitting input from the user; a base member including at least one power surge protected outlet; a built-in camera obtaining an image in front of the television; a plurality of input and output connectors; and a plurality of push buttons for controlling features of the television.

In another aspect of the present invention, an interactive television comprises a touch screen for displaying items to a user and for permitting input from the user; a base member including at least one power surge protected outlet;

a built-in camera obtaining an image in front of the television; a plurality of input and output connectors; a plurality of push buttons for controlling features of the television; a remote control having a plurality of buttons; one or more speakers disposed in a television housing; a slot for inputting at least one of a CD, a DVD and a video disc; and a power cord for delivering power to the television and a power cord storage compartment for storing the power cord therein.

These and other features, aspects and advantages of the present invention will become better understood with reference to the following drawings, description and claims.

### BRIEF DESCRIPTION OF THE DRAWINGS

FIG. 1 is a front perspective view of an interactive television, listing the various features included therewith, according to an exemplary embodiment of the present invention;

FIG. 2 is a back perspective view of the interactive television of FIG. 1;

FIG. 3 is a left side view of a remote control device usable with the interactive television of FIG. 1;

FIG. 4 is a front view of a remote control device of FIG. 3;

FIG. 5 is a side view of the remote control device of FIG. 3;

FIG. 6 is a perspective view of 3-D glasses usable with the interactive television of FIG. 1; and

FIG. 7 is a perspective view of a power cord usable with the interactive television of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

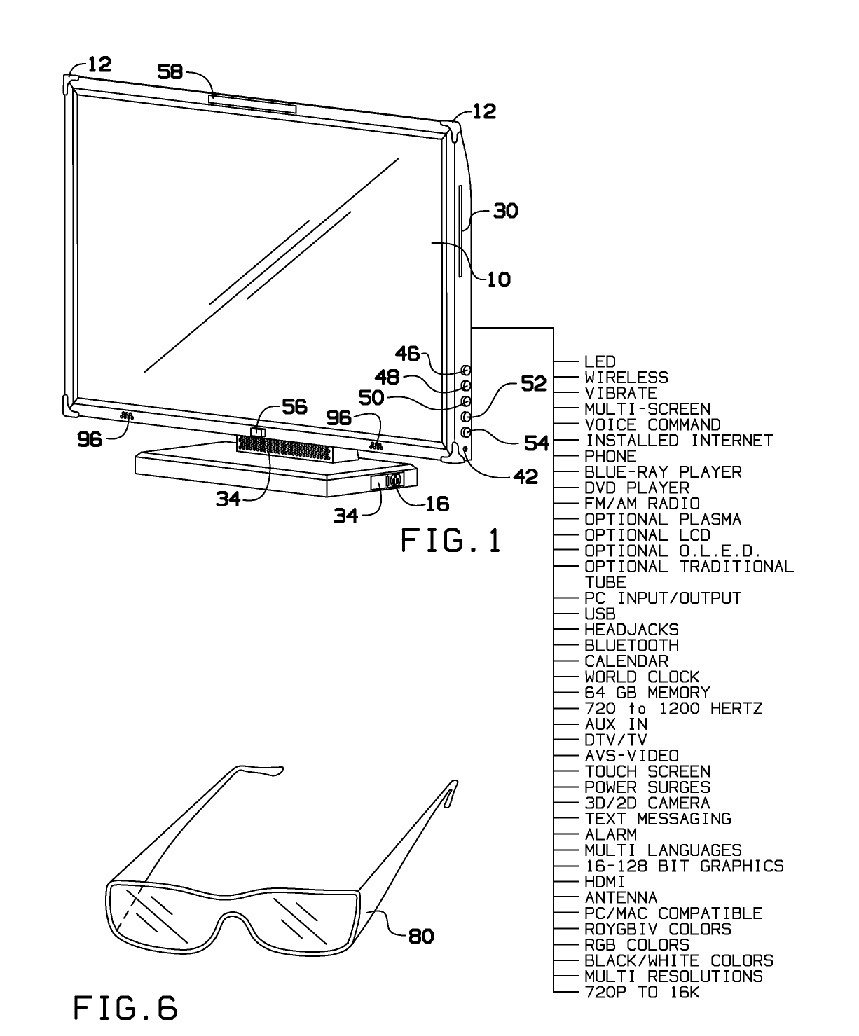

Broadly, an embodiment of the present invention provides an interactive television that includes a plurality of features not available in a single television device. The interactive television includes a touch screen and can include features such as wireless internet access, a three-dimensional camera, a built-in surge protector, a surge protected outlet in the television base, and the like. The interactive television can include software for displaying time, time zones, calendars and the like. The interactive television can include an alarm clock and can be used for text messaging. The interactive television can include several technological advances in a single device, providing the user with a complete, interactive television experience. The interactive television can include an interactive remote control having buttons matching the buttons available on the television, as well as a touch screen for remotely accessing the television's own touch screen. The interactive television can have a screen size up to about 60 inches or greater and can retain an ultra-slim thickness profile, for example, of less than about 3 inches. The interactive television can use various technologies for its display. FIG. 1 shows examples of these technologies, including plasma, LCD, OLED, and the like. Typically, the television uses one of these technologies for its display output.

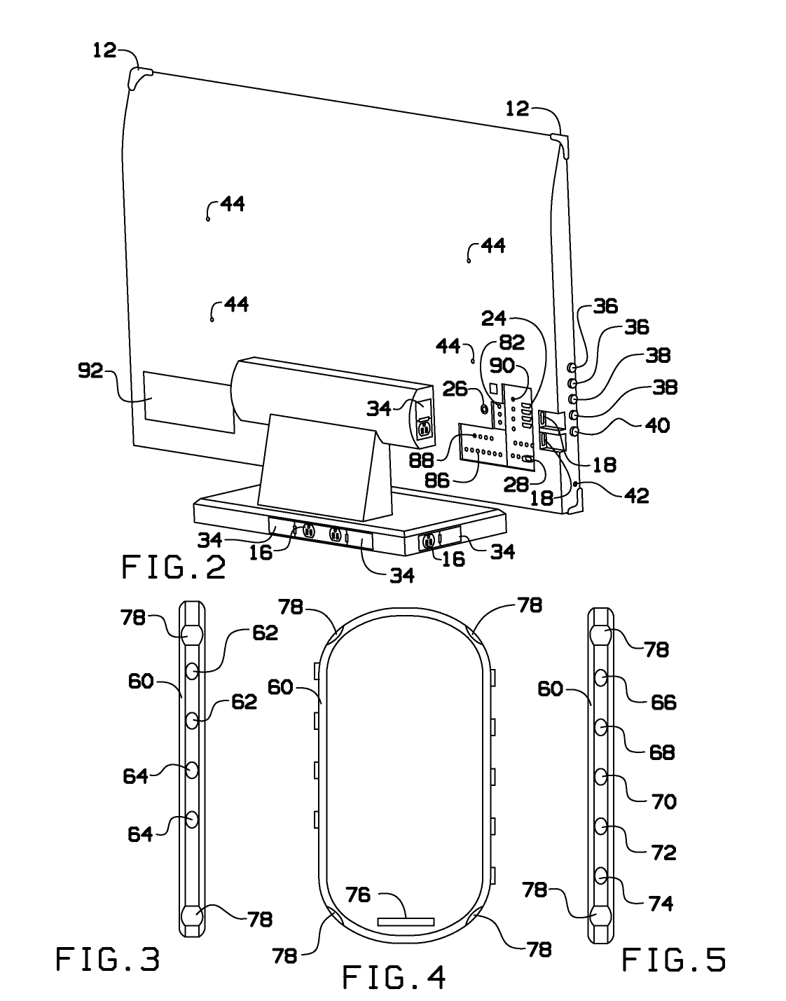

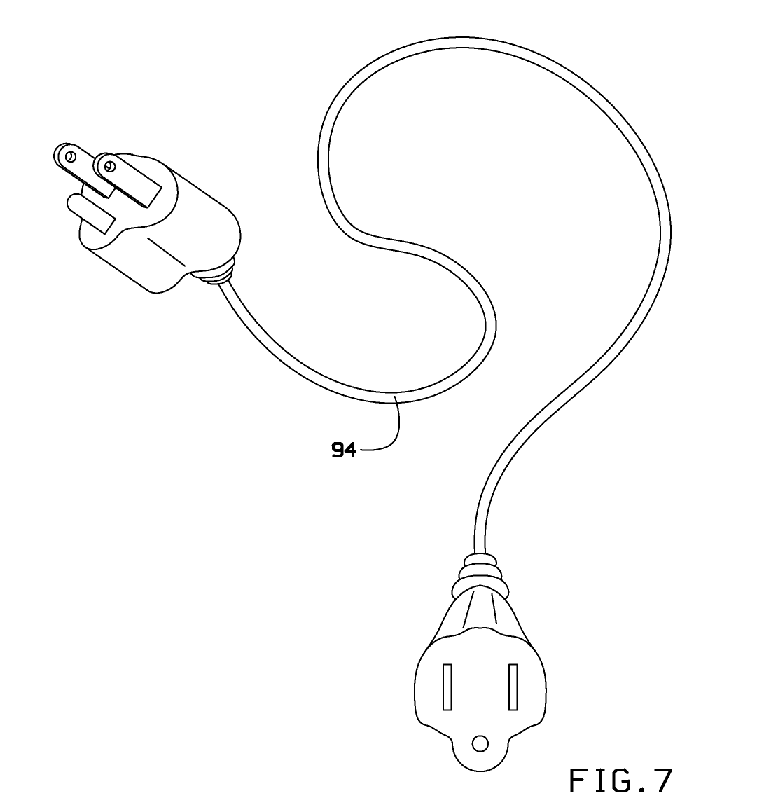

Referring now to FIGS. 1 through 7, an interactive television can include a touch screen 10 having a metal plate cover 12. A power surge protector can be built into the television, and a power surge protected outlet 16 can be provided in the base of the television. A power sure spring loaded cover 34 can protect access to the surge protector in the base of the television. The cover 34 can provide access to, for example, a surge protector reset switch.

The television can include various input and output ports, such as one or more USB ports 18, one or more HDMI ports 20, an antenna port 26, a PC port 28, a stereo audio port 82, a SPDIF audio port 84, component ports 86, an audio port 88, an audio output port 90, and the like. These ports can allow the interactive television to send and receive signals to various other devices.

The television can include a built-in player for CDs, DVDs, Blu-Ray discs, or the like. The player can be accessed, for example, via a slot 30 in the side of the television.

One or more speakers 96 can be provided in the television to output television sound directly from the interactive television. In some embodiments, one or more speakers can be provided in the television base.

The television can be designed to use multiple colors to provide a vivid image. Conventional televisions are often RGB-type televisions, referring to the use of red, green, and blue colors to create an image. The television of the present invention can use up to seven colors, typically the colors of red, orange, yellow, green, blue, indigo and violet. This can provide a more vivid image as compared to conventional RGB-type television displays.

The television can include options to change the video resolution. For example, the television can select various resolution outputs between 720 and about 16,000, which is about 16 times greater than 1080 p.

Various buttons can be provided on the television. For example, a volume push button 36, a channel push button 38, an AV/TV push button 40, a record push button 46, a reverse push button 48, a play push button 50, a pause push button 52, a forward push button 54 and an on/off push button 56 can be provided at various locations on the television. These buttons can provide direct access to basic functions of the television. The touch screen 10 can provide access to most, if not all, of these features. The television can be enabled to assist users with various accessibility functions, such as acting as a TTY or TDD device.

The television can be displayed on its base. In some embodiments, the television can be wall mounted. One or more wall mount holes 44 can be provided on the back of the television for wall mounting.

The television can include a camera 58, such as a three-dimensional camera. The camera 58 can allow the user to send their image to a recipient, such as when sending a text message, talking on the phone, or the like. Three-dimensional glasses 80 can be used to view a three-dimensional image displayed on the television. The television can also link to a phone system to place or receive phone calls or display caller ID information. One or more of the cameras 58 can be used with the television. In some embodiments, one of the cameras 58 can be a video camera.

The television can include a remote control 60 for accessing features of the television in a remote manner. The remote control 60 can include a plurality of buttons, such as a volume button 62, a channel button 64, a record button 66, a play button 68, a reverse button 70, a forward button 72, a stop button 74, and an on/off button 76, for example. The remote control 60 can be held in a housing 78, such as a metal housing. The remote control 60 can also include a touch screen that can mimic the touch screen shown on the television.

A power cord 94 of the television can be stored, for example, in a cord storage compartment 92 when not in use.

The television of the present invention can not only communicate sound to a distance, but can also allow the user to watch multiple images on a screen, while searching the screen to find out information. The television can be useful for looking at sports, playing video games, watching movies, designing and office work. With the ability of viewing multiple images, a user can, for example, watch an event on a television while playing a video game. The camera 58 can be capable of taking a snapshot of a natural pose of a person or of a living animal and object. The camera 58 can be capable of displaying a three dimensional (3D) image, and particularly to the capability of switching between a two dimensional (2D) image and a (3D) image. A digital camera with a function for displaying a (3D) three dimensional image is equipped with a pair of imaging devices that are apart from one another by a distance based on a binocular parallax or disparity. When recording a three dimensional image, the camera photographs a target object by using both of the imaging devices to generate one photographic image for a left eye and one photographic image for a right eye. Then, the photographic images for left and right eyes are displayed alternately on a display unit such as a L.E.D., in accordance with a parallax barrier method or lenticular lens method. A three-dimensional (3D) video camera and associated control method, and more particularly, to a three-dimensional (3D) video camera comprising a plurality of camera lenses of different grades and associated control method. The television itself can display 3D images or can be used in a 2D mode as well.

The television of the present invention can extend the range of Bluetooth communications and allows an essentially open path of communication to be established between the television screen and remote controller, even when those devices are otherwise out of range.

The television can be designed to operate at frequencies from about 720 hertz to 1200 hertz for clear motion, fame by fame. With up to 6400 GB of memory, for example, the television can quickly load files and other data for use by the user. This memory can also be used to store various applications that the user can download and use with the television. The television can include logic for controlling the various features. This logic can include one or more central processing units (CPUs), such as those made by Intel, for example.

The television can include one or more video tuners, a built-in digital video recording device, and a radio tuner. The radio tuner can be accessed, for example, through an on-screen display, via the remote control, or via buttons provided on the television. The television can get input through a wireless signal, such as from the internet. The wireless signal can be accessed through various technologies, such as WiFi, Ethernet, Bluetooth, or the like. The signal can be used to communicate with devices such as PCs and Mac computers.

The television of the present invention solves the availability problems that most televisions lack. The television of the present invention includes a world clock capable of displaying the time at any place in the world simple by touching the place on the world map shown on the menus of the television screen. The world clock can display the time information on each region of the world specified arbitrarily by the user.

The television of the present invention can provide a system and techniques for tracking text messages. Identification of message threads in short text messaging, thereby facilitating relay messaging between users. An adaptation layer may be stored in a player that supports DVD and Blu-ray Disc by reading each discs data separately. The adaptation layer laser can switch from red laser longer wavelength (about 650 nanometers) for Digital Versatile Discs (also known as Digital video Discs or DVDs) and Compact Discs (CDs) standard; to Blue laser short wavelength (about 405 nanometers) for the Blu-ray Discs with high-definition video and games.

The television can include LED displays that are touch-input enabled, and methods for using the finger or stylus touch user inputs on a touch sensitive screens. The touch screens can be capable of being used in both a single-touch mode and a multi-touch mode. The television can include a device for generating a vibration source driving signal, where internal vibration units can be aimed at providing feedback from television enthusiasts with an immersive sound experience that will dynamically add to the excitement and enjoyment of the latest action-packed movies and video game-consoles. In some embodiments, the television may be operated with voice commands, including a voice command prompt system, where the television may ask the user a series of questions to adjust various settings. Adjustment of the settings and the optional voice command prompt and response understanding could be accomplished in any language. The television can include a feature for the user to select a language from a list of language.

It should be understood, of course, that the foregoing relates to exemplary embodiments of the invention and that modifications may be made without departing from the spirit and scope of the invention as set forth in the following claims.

What is claimed is:

1. An interactive television comprising:
a touch screen for displaying items to a user and for permitting input from the user;
a base member including at least one power surge protected outlet;
a built-in camera obtaining an image in front of the television;
a plurality of input and output connectors; and
a plurality of push buttons for controlling features of the television.

2. The interactive television of claim 1, further comprising a power cord for delivering power to the television and a power cord storage compartment for storing the power cord therein.

3. The interactive television of claim 1, further comprising software, encoded on a non-transient computer readable medium within the television, the software providing functionality for an alarm clock, a calendar and a world time zone map.

4. The interactive television of claim 1, wherein the plurality of input and output connectors include at least one USB port, at least one HDMI port, a PC port, an antenna port, an audio input port, and an audio output port.

5. The interactive television of claim 1, wherein the built-in camera is a three-dimensional camera.

6. The interactive television of claim 1, further comprising a remote control having a plurality of buttons.

7. The interactive television of claim 1, further comprising one or more speakers disposed in a television housing.

8. The interactive television of claim 1, further comprising a slot for inputting at least one of a CD, a DVD and a video disc.

9. An interactive television comprising:
a touch screen for displaying items to a user and for permitting input from the user;
a base member including at least one power surge protected outlet;
a built-in camera obtaining an image in front of the television;
a plurality of input and output connectors;
a plurality of push buttons for controlling features of the television;
a remote control having a plurality of buttons;
one or more speakers disposed in a television housing;
a slot for inputting at least one of a CD, a DVD and a video disc; and
a power cord for delivering power to the television and a power cord storage compartment for storing the power cord therein.

10. The interactive television of claim 9, further comprising software, encoded on a non-transient computer readable medium within the television, the software providing functionality for an alarm clock, a calendar and a world time zone map.

11. The interactive television of claim 9, wherein the plurality of input and output connectors include at least one USB port, at least one HDMI port, a PC port, an antenna port, an audio input port, and an audio output port.

12. The interactive television of claim 9, wherein the built-in camera is a three-dimensional camera.
